(19) United States
(12) Patent Application Publication
(10) Pub. No.: US 2006/0126664 A1
(43) Pub. Date: Jun. 15, 2006

(54) Systems and methods for dynamic modification of a stream of data packets

(76) Inventor: David Horton, Marlborough, MA (US)

Correspondence Address: CHOATE, HALL & STEWART LLP, TWO INTERNATIONAL PLACE, BOSTON, MA, 02110, US

(21) Appl. No.: 11/292,750

(22) Filed: Dec. 1, 2005

Related U.S. Application Data
(60) Provisional application No. 60/632,290, filed on Dec. 1, 2004.

(51) Int. Cl. H04J 3/22; H04J 3/16

(52) U.S. Cl. 370/471

(57) ABSTRACT

Systems and methods for a VoIP session controller product that combines high performance packet processing throughput with low cost, based on a design that dynamically moves packet processing between user space and kernel based on individual call parameters.

### FIELD OF THE INVENTION

The present invention relates generally to voice-over internet-protocol (VOIP) session controllers and, more specifically, to VoIP session controllers for dynamically processing data packets between networks.

### BACKGROUND OF THE INVENTION

In a traditional general-purpose session controller, the processing of data packets is implemented by processes. “Session controllers” represent a growing product category in the overall VoIP space. Session controllers are generally elements that sit between two different service provider's VoIP network and pass both call signaling messages and audio packets between the two networks, thereby allowing the interworking of the two networks.

There are two general embodiments of session controllers: those built on special purpose hardware, and those built on general-purpose hardware. Special-purpose hardware based session controllers generally offer higher packet processing rates, but are less flexible and more expensive due to the reliance on special hardware and the associated turnaround times for making changes in the hardware or firmware. General-purpose session controllers typically offer greater flexibility and lower cost, but generally reduce scalability because more of the processing is done in software rather than hardware.

As packets arrive at an interface between two networks, they are received by the network interface controller (NIC), read from the NIC by a device driver, and passed by an operating system kernel to a process. The kernel may be, for example, a Linux kernel. The user process generally performs processing required on the packets, such as forking, or dual tone multi frequency (DTMF) detection, and then sends the packets through the kernel, to the device driver, and out the NIC to the destination network. This allows for great flexibility since user processes have great latitude to perform all sorts of computations or operations on the incoming data. Such processing may slow performance due to the many levels through which each incoming packet must traverse, however, the overhead in the transition from kernel mode to user mode must occur for every processed packet.

Alternatively, a session controller could be built entirely as a kernel module in order to achieve higher performance, but that would limit the flexibility of the different operations that could be performed on the data packets, since (as one example) many third party software libraries are not designed to be linked into the kernel. Existing DTMF detection and speech recognition third party libraries, for instance, may not be able to be used.

### SUMMARY OF THE INVENTION

From the foregoing, it is apparent that there is still a need for dynamic packet processing throughput that maintains a high level of performance. Further, it is desirable to optimize overall packet processing without impacting the ability to provide a wide range of operations on a stream of data packets. While the following description particularly addresses VoIP session controllers for processing audio data packets, VoIP session controllers could be used on any streams of data packets (“streams”).

In one embodiment, the present invention relates VoIP session controller systems and methods with high performance packet processing throughput. To increase efficiency, the present invention dynamically moves packet processing between user space and a kernel based on individual call parameters. Further, the present invention may combine flexible, low cost applications with high packet processing rates.

In a preferred embodiment, a function that a session controller element according to the present invention may provide includes additional security, because having the session controller “front end” all of the traffic allows the service provider to keep all the other telecommunication equipment in a more secure private network. Session controllers are typically deployed in the service provider's demilitarized zone, or DMZ. Without a session controller all of the elements involved in processing a call would need to exposed to outside networks, such as the Internet, in some fashion.

In a preferred embodiment, a session controller element may provide forking, or duplication, of media streams, for requirements such as federal wiretapping requirements (i.e., the Communications Assistance for Law Enforcement Act, or CALEA). As the media streams pass through the session controller, they can be duplicated and sent to other destinations as necessary to support requirements such as or example those contained in the CALEA.

In some embodiments, the session controller includes DTMF detection, and automatic speech recognition that can be performed on the media stream as it passes through the session controller.

The session controller, in some embodiments, may also include session invitation protocol (SIP) interworking. Generally, SIP is a VoIP signaling protocol. Differences in SIP implementations between two different service providers vendor equipment can lead to interworking problems; often, session controllers, since they sit between the two sets of gear, are called on to “fix up” interworking problems such as these.

The session controller of the present invention is also capable of transcoding. Transcoding is generally the modification of a media stream from one compression algorithm to a different one as it passes between networks. In another embodiment, the session controller includes network address translation (NAT) traversal. NAT traversal is generally the ability to send signaling and media streams to SIP devices that sit behind a firewall or NAT device.

The invention features a method for dynamically routing, by a session controller associated with an operating system, a stream of data packets passed from a first network to a second network. In one aspect, the invention intercepts, by a session controller connected to both a first network and a second network, a stream of data packets traveling from the first network to the second network. The stream of data packets are then processed and the path of the stream of data packets is dynamically changed by the session controller, as well as its corresponding operating system and device drivers, and the stream of data packets is then forwarded to a specified destination.

In certain embodiments, this specified destination is the final destination of the stream of data packets, such as the telephone receiver on the second network where, for example, a person may listen to the stream of data packets in audio form—In other embodiments, the stream of data packets may be forked, whereby the stream is send to multiple destinations. For example, the stream of data packets may be sent to both the human end user (listener), and a recording device, as in the case of a wiretap.

In another aspect, the invention features a system including a session controller, associated with an operating system, for dynamically routing a stream of data packets as the stream is routed from a first network to a second network. The invention features a session controller that is connected to both the first network and the second network for intercepting a stream of data signals passing between the two networks. A processor then processes the intercepted stream of data signals to determine the nature of the stream. The session controller then dynamically changes the path of the data stream based on the nature of the stream of data signals, and forwards the stream to a specified destination accordingly.

Other aspects and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other objects, features, and advantages of the present invention, as well as the invention itself, will be more fully understood from the following description of various embodiments, when read together with the accompanying drawings, in which:

FIG. 1 is a flowchart depicting a method for dynamically routing a stream of data packets in accordance with an embodiment of the invention.

FIG. 2 is a block diagram depicting a system for dynamically routing a stream of data packets in accordance with an embodiment of the invention.

### DETAILED DESCRIPTION

As shown in the drawings for the purposes of illustration, the invention generally includes the use of a operating system kernel module working in conjunction with a user process to dynamically modify the handling of audio packets within the operating system during a conversation so as to optimize overall packet processing without impacting the ability to provide a wide range of operations on the audio stream.

Generally, the invention implements a session controller on general-purpose hardware and an operating system that combines the flexibility and low cost of traditional general-purpose solutions with higher packet processing rates than were available with these solutions. In a preferred embodiment, the general purpose hardware may include Intel© x86 architecture, and the operating system may be a Linux operating system. In other embodiments, the operating system can be, without limitation, WINDOWS 3.x, WINDOWS 95, WINDOWS 98, WINDOWS NT 3.51, WINDOWS NT 4.0, WINDOWS 2000, WINDOWS XP, WINDOWS VISTA, WINDOWS CE, MAC/OS, Java, PALM OS, SYMBIAN OS, LINSPIRE, SMARTPHONE OS, and the various forms of UNIX.

The invention recognizes that each media stream has different requirements in terms of the treatment required by the session controller on the media stream, and that optimizing the path of the packets through the operating system kernel and user process based on these requirements achieves higher packet throughput without sacrificing flexibility.

For example, a session controller may be processing 1,000 streams that require simple packet forwarding processing, and another 200 which additionally require DTMF detection. Furthermore, the characteristics may change during an individual call. For example, of the 1,000 streams being forwarded, it may become necessary during one of those calls to start forking the stream in order to wiretap it, or to start applying automatic speech recognition in order to spot a “hotword.” Generally, a hotword is a preselected word that is detected by automatic speech recognition. Later in the call the requirement may change again, so that once again only packet forwarding is required. The session controller will dynamically change the path of the packets through the operating system and device drivers during a call based on these requirements to provide optimal packet processing without sacrificing flexibility.

A preferred embodiment includes the Linux operating system. Alternative embodiments may include any other operating system known to one of ordinary skill in the art. Linux operating system architecture is generally a multiple layered architecture. The layers of a Linux operating system include the actual hardware; e.g., CPUs, disk, network interface cards (NICs), as well as device drivers that manage physical devices such the NICs; a Linux kernel, which is the core of the operating system; device drivers that “plug into” and are controlled by the Linux kernel; Kernel modules, which provide additional flexibility for code to be linked dynamically into the Linux kernel at run time; and finally, user processes, which is where general purpose applications typically run.

In the session controller of the present invention, the path a specific media stream takes through these software layers can be different than the path other streams take, and can even change during a call. The present invention implements a kernel module that intercepts the incoming packet streams in the operating system kernel, and can either: forward the stream immediately out to its final destination; accept the stream up to a waiting user level process for further processing; forward the stream to specialized hardware (e.g., a field programmable gate array) for processing; or discard the packets.

The decisions about how to route a specific media stream are typically made by a user level process that communicates handling instructions to the kernel module for specific streams based on the session initiation protocol (SIP) signaling protocol and other information. For example, in a preferred embodiment a series of SIP messages may establish a need to provide simple packet forwarding for a media stream arriving on a specific (user datagram protocol) UDP port. The instruction sent by the user process to the kernel module is: “Send all UDP packets arriving on port 20,000 to remote IP address 10.10.10.100, port 21,000”. At that point the kernel module will begin intercepting all such packets and forwarding them to the destination specified, without the overhead of passing each packet up to the user process. Later, the user process may be notified that this media stream must be wiretapped. Because a forking operation must now be applied to the media stream, the stream must now be passed up to the user level. The instruction sent by the user process to the kernel module is then: “Stop forwarding UDP packets arriving on port 20,000 and send them up to user level”. At another later time, the user process may be notified that this media stream should be processed by a specialized hardware device. The instruction sent by the user process to the kernel module is then: “Stop forwarding UDP packets arriving on port 20,000 and send them to the specialized hardware device”.

At this point the kernel module allows these packets to pass up to user level, where additional processing may be performed on them as required. Later in the call, the user process may determine that only packet forwarding is required and can then issue another instruction to begin forwarding the packets again. These changes in packet routing through the system can be made dynamically during the call, without either side detecting any anomalies in the audio connection that would indicate any sort of redirection of modification of the audio processing has occurred.

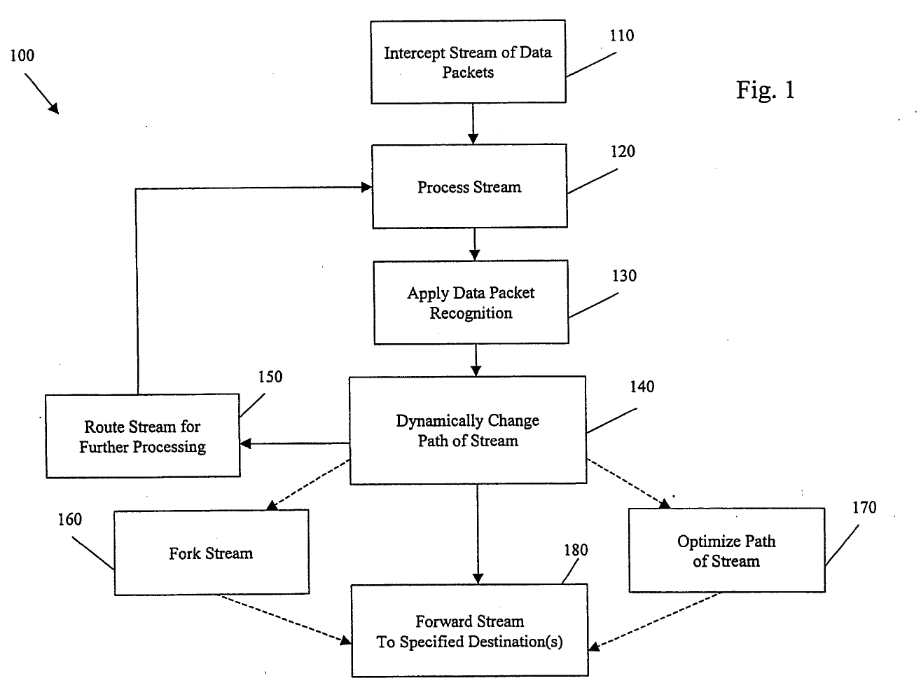

In brief overview, FIG. 1 is a flowchart 100 depicting a method for dynamically routing a stream of data packets in accordance with an embodiment of the invention. In one aspect the invention features a method for dynamically routing a stream of data packets traveling from a first network to a second network by a session controller where the session controller associated with an operating system. Note that in some embodiments the first network and the second network may be encompassed by a single, larger network. For example, the stream of data packets may represent a human voice, and these data packets may be traveling from one telephone to another telephone on the same overall telephone network.

The method includes the step of intercepting a stream of data packets traveling from a first network to a second network (STEP 110). Generally, interception includes receiving the steam of data packets before the stream reaches its originally intended destination. Typically, the interception does not alter the content of the stream of data packets. In some embodiments, this interception may be implemented via use of a session controller.

Next, the method includes the step of processing the stream of data packets (STEP 120). Generally, processing the stream of data packets includes an analysis of the stream for particular characteristics. In a preferred embodiment, the stream may be processed to determine the existence of a particular data sequence that may correspond to a “hotword”. In an alternate embodiment, the stream may be processed to determine the presence of a particular tone that corresponds to the speech pattern of a particular individual.

In one embodiment, the processing may be implemented by the session controller. In a preferred embodiment, once a particular data sequence is noticed during processing (STEP 120), the method 100 applies data packet recognition (STEP 130). Applying data packet recognition (STEP 130) may assist in dynamically changing the path of the stream of data packets (STEP 140). Generally, dynamically changing the stream path (STEP 140) includes redirecting the stream. In some embodiments, the step of dynamically changing the stream path (STEP 140) may include determining, from the processed information gleaned from the stream during processing (STEP 120), that the stream of data packets may proceed to its original destination without altering its path. In other embodiments, the path of the stream of data packets is altered so that the stream proceeds to a destination different than the one the stream of data packets was originally directed towards. The different destination can include a different process (e.g., a user process or application) or a different physical location (e.g., a specialized hardware device or network location). In an alternative embodiment, (STEP 140) routes the stream of data packets for further processing (STEP 150). Typically, further processing STEP 150 enables additional analysis of the contents of the stream, to determine, for example, if the stream needs to be monitored by a third party. In general, (STEP 140) directs the stream to at least one of any available ends.

In some embodiments, the method 100 forks the stream of data packets (STEP 160). Generally, forking the stream of data packets (STEP 160) includes directing the complete stream to multiple destinations. For example, during the course of a phone call, if data packet recognition (STEP 130) recognizes a hotword embedded in the stream of data packets indicating that the call is to be monitored by someone other than the originally intended end listener, (STEP 160) forks the stream of data packets so that one complete stream goes to the originally intended end user, and another identical stream of data packets is monitored by a third party. Generally, this is undetectable to either of the two parties involved in placing or receiving the phone call.

In an alternative embodiment, the method 100 may also include the step of optimizing the path of the stream of data packets (STEP 170). Generally, this optimization step 170 enables the method to achieve the highest possible packet throughput, or in other words, high stream flow of the stream of data packets from their source to their destination.

Finally, method 100 forwards the stream of data packets to a specified destination (STEP 180). Generally forwarding (STEP 180) includes sending the complete segment of the stream of data packets that was intercepted (STEP 110) to at least one specified destination. In an alternate embodiment, the complete segment of the stream of data packets that was intercepted (STEP 110) maybe replicated to enable multiple identical streams to be sent to separate specified destinations. For example, a stream segment corresponding to a telephone conversation that contains a hotword recognized daring the application of data packet recognition (STEP 130) may cause the entire segment to be sent to a recorder for monitoring by someone other than the original recipient of the phone call. In parallel, a replica of the same stream segment will be sent to the originally intended recipient (end listener) of the phone call. Generally, neither of the original parties to the phone call is aware of the stream of data packets corresponding to their speech has been forked.

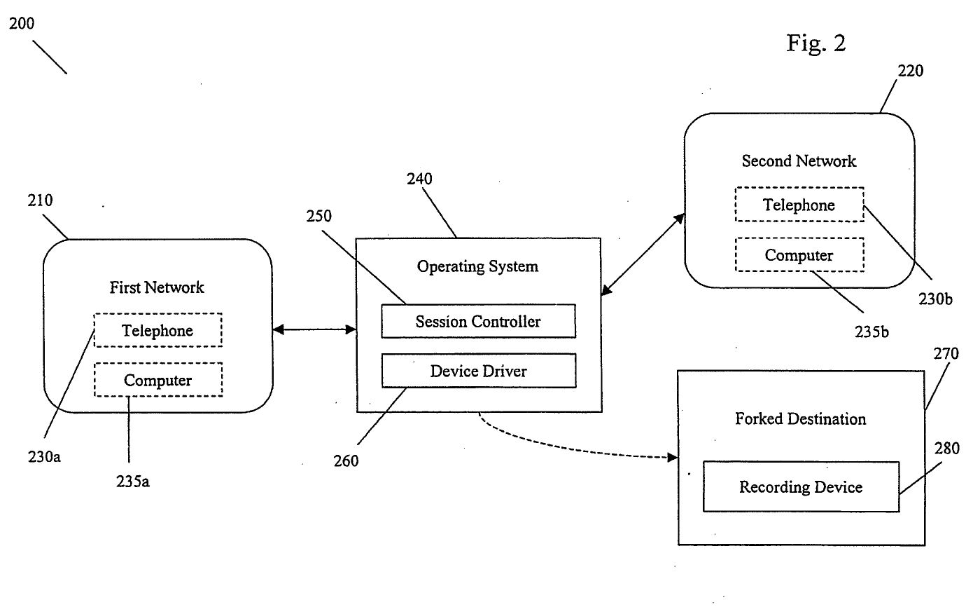

In brief overview, FIG. 2 is a block diagram depicting a system 200 for dynamically routing a stream of data packets in accordance with an embodiment of the invention. In one aspect, the invention features a system for dynamically routing, by a session controller associated with an operating system, a stream of data packets passed from a first network to a second network.

The system 200 includes both a first network 210 and a second network 220. In a preferred embodiment, the first network 210 includes at least one telephone 230a, and the second network includes at least one telephone 230b. Alternatively, the first network 210 may include at least one computer 235a, and the second network includes at least one computer 235b. Generally, each of the first network and the second network are capable of transmitting and receiving a stream of data packets. In a preferred embodiment, this stream of data packets may represent audio signals corresponding to human speech. In some embodiments, the network 210 and the network 220 may be part of a larger single network (not shown) such as an all encompassing telephone network. In the preferred embodiment, the stream of data packets is capable of being transmitted and received by either of the first network 210 or the second network 220, or any sub-components of either network.

Connected to the link between the first network 210 and the second network 220 through which the stream of data packets passes, is operating system 240. In some embodiments, operating system 240 may include a Linux operating system. Operating system 240 includes a session controller 250. Generally, the session controller 250 as defined above allows intercommunication between the first network 210 and the second network 220. The session controller 250 intercepts a stream of data packets as they are traveling between the first network 210 and the second network 220. The streams of data packets may be traveling to or from either network. In addition to being associated with operating system 240, the session controller 250 also generally is associated with a processor (not shown). This may be the operating system 240 processor. In a preferred embodiment, the session controller 250 and associated operating system 240 direct the processing of the stream of data packets. The stream of data packets is typically processed to determine the existence of a particular sequence, such as a hotword, or any predetermined event or sequence associated with the stream of data packets, for example.

As a result of the session controller 250 and associated processor processing the stream, the session controller 250 next dynamically changes the path of the stream of data packets. By dynamically changing the path, neither the original sender nor originally intended recipient of the stream of data packets is aware that the stream may have been intercepted, processed, or dynamically changed. The operating system 240 may also include a device driver 260 to assist in the dynamic change in the path of the stream of data packets.

Finally, the session controller 250 forwards the stream of data packets to a specified destination. In some embodiments, this destination is the original end user, such as the originally intended recipient of a phone call, or VoIP communication, (i.e., the end user at the telephone 230b or the computer 235b). In other embodiments, the session controller 250 may fork the stream. In the preferred embodiment, when the stream is forked it is typically replicated and sent to more than one specified destination. In an alternative embodiment, the stream may be diverted in its entirety, and does not reach the originally intended recipient.

In some embodiments the specified destination may include the second network 220. In other embodiments, the second network may include a forked destination 270. Generally the forked destination 270 may include any destination for the stream of data packets other than the originally intended destination. The originally intended destination may include the subject destination intended by a user responsible for the creation of the stream of data signals, such as a person placing a phone call.

In some embodiments, the forked destination may include a recording device 280. Typically the recording device includes any device, such as hardware, capable of fixing in a tangible medium or otherwise recording the stream of data packets. In some embodiments, the recording device 280 records the stream of data packets as audible signals, such as human speech for example. In an alternate embodiment, the forked destination 270 may be monitored in real time by a third party, (i.e. anyone other than the intended recipient of the stream of data packets).

For example and as an illustrative embodiment, the stream of data packets may be a human speech traveling from one telephone to another during the course of a phone call. This stream is intercepted before reaching its intended recipient. This intercepted stream of data packets is then processed by the session controller 250. In one embodiment, the stream of data packets may be processed to determine if a match exists between the processed signal and a preselected pattern, such as the tone of a particular individual's voice, or a selected word. In this illustrative embodiment, if such a match exists, the stream of data packets may be forked, where the stream goes to both the second network 220 and a forked destination 270.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

The previously described embodiments may be implemented as a method, apparatus or article of manufacture using programming and/or engineering techniques to produce software, firmware, hardware, or any combination thereof. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.), a file server providing access to the programs via a network transmission line, wireless transmission media, signals propagating through space, radio waves, infrared signals, etc. The article of manufacture includes hardware logic as well as software or programmable code embedded in a computer readable medium that is executed by a processor. Of course, those skilled in the art will recognize that many modifications may be made to this configuration without departing from the scope of the present invention.

What is claimed is:

1. A method for dynamically routing, by a session controller associated with an operating system, the handling of a stream of data packets passed between a first network and a second network comprising:
(a) intercepting, by a session controller that connects a first network and a second network, a stream of data packets traveling from the first network to the second network;
(b) processing, by the session controller, the stream of data packets; and
(c) forwarding the stream of data packets to a specified destination.

2. The method of claim 1 wherein processing, by the session controller, the stream of data packets further comprises applying data packet recognition to detect a preselected data packet from the stream of data packets.

3. The method of claim 1 wherein dynamically changing the path of the stream of data packets through the operating system and at least one of a device driver comprises optimizing the path of the stream of data packets through use of a kernel of the operating system.

4. The method of claim 1, wherein dynamically changing the path of the stream of data packets through the operating system and at least one of a device driver comprises forwarding the stream of data packets to its final destination.

5. The method of claim 1, wherein dynamically changing the path of the stream of data packets through the operating system and at least one of a device driver comprises routing the stream of data packets to a processor for further processing.

6. The method of claim 1, wherein dynamically changing the path of the stream of data packets through the operating system and at least one of a device driver comprises discarding the stream of data packets.

7. The method of claim 1, further comprising forking the stream of data packets to two or more than specified destinations.

8. The method of claim 1, wherein the stream of data packets comprise audio signals.

9. A system for dynamically routing, by a session controller associated with an operating system, a stream of data packets passed from a first network to a second network comprising:
(a) a session controller connected to both a first network and a second network for intercepting a stream of data packets traveling from the first network to the second network; and
(b) a processor associated with the session controller and an operating system of the session controller, processing the stream of data packets;
(c) the session controller dynamically changing the path of the stream of data packets by the session controller through an operating system of the session controller and a device driver; and
(d) the session controller forwarding the stream of data packets to a specified destination.

10. The system of claim 9 wherein the session controller applies data packet recognition to detect a preselected data packet from the stream of data packets.

11. The system of claim 9 wherein a kernel of the operating system associated with the session controller and a device driver optimize the path of the stream of data packets.

12. The system of claim 9 wherein the specified destination includes a final destination,

13. The system of claim 9 wherein a processor associated with both the operating system and the session controlled further processes the stream of data packets.

14. The system of claim 9 wherein the session controller forwarding the stream of data packets to a specified destination comprises discarding the stream of data packets.

15. The system of claim 9 wherein the session controller forks the stream of data packets to two or more specified destinations.

16. The system of claim 9 wherein the stream of data packets comprise audio signals.

17. A method for routing a stream of data packets in a communications system, the method comprising:
(a) intercepting, by a kernel module of the session controller, a stream of data packets traveling from an origin to a predetermined destination;
(b) processing, by the kernel module of the session controller, the stream of data packets; and
(c) forwarding the stream of data packets to the predetermined destination upon completion of the processing.

18. The method of claim 17 further comprising forwarding a portion of the stream of data packets to an application executing on the session controller for processing by the application prior to forwarding the stream of data packets to the predetermined destination.

19. The method of claim 17 further comprising forwarding a portion of the stream of data packets to a hardware device in communication with the session controller for processing by the hardware device prior to forwarding the stream of data packets to the predetermined destination.

20. The method of claim 19 wherein the hardware device is a field programmable gate array.
